(19) United States
(12) Patent Application Publication
(10) Pub. No.: US 2018/0276294 A1
(43) Pub. Date: Sep. 27, 2018

(54) INFORMATION PROCESSING APPARATUS, INFORMATION PROCESSING SYSTEM, AND INFORMATION PROCESSING METHOD

(71) Applicant: NEC Personal Computers, Ltd., Tokyo (JP)

(72) Inventor: Tsuyoshi Takemoto, Tokyo (JP)

(73) Assignee: NEC Personal Computers, Ltd., Tokyo (JP)

(21) Appl. No.: 15/468,953

(22) Filed: Mar. 24, 2017

(51) Int. Cl. G06F 17/30

(52) U.S. Cl. CPC G06F 17/30696; G06F 17/30713; G06F 17/30011; G06F 17/30657

(57) ABSTRACT

The present invention provides an information processing apparatus which appropriately acquires a content associated with a document and displays the content together with the document. The information processing apparatus includes: a database section which stores term clusters in each of which terms similar in appearance tendency in the documents are grouped, and document clusters in each of which documents similar in term appearance tendency are grouped; a word extraction section which extracts a word from a specified document; a document cluster identifying section which identifies, based on the extracted word, a document cluster associated with the specified document; a keyword selection section which selects, as a keyword, a term appearing in the identified document cluster; a content acquisition section which acquires, from a network, a content associated with the selected keyword; and a display section which displays the acquired content together with the specified document.

### FIELD OF THE INVENTION

The present invention relates to an information processing apparatus, an information processing system, and an information processing method, which select a content associated with a document viewed by a user and display the content together with the document.

### BACKGROUND OF THE INVENTION

When a user has a limited amount of time to view countless pieces of information transmitted over the Internet from day to day, it is extremely important for the user to make a choice of information. In Patent Document 1, a technique is described, which collects information associated with information being viewed, and displays the information on the same screen to enable efficient information viewing.

[Patent Document 1] Japanese Patent Application Publication No. 2014-215949

### SUMMARY OF THE INVENTION

In Patent Document 1, information acquired by making a search using, as search words, a keyword extracted from target content information and an additional word defined for a category to which the target content information belongs is displayed in a screen area. Thus, the information associated with the target content information is displayed to enable efficient information viewing.

The keyword can be extracted from the content information by referring to a proper noun dictionary or the like, but the keyword may not appropriately represent the content information. Further, even the same keyword may have a different meaning from user to user, such as homonyms or the name of a person who plays an active role in plural fields. In such a case, information associated with a target content cannot be selected and displayed appropriately.

It is an object of the present invention to provide an information processing apparatus which appropriately acquires a content associated with a document and displays the content together with the document.

In order to solve the above-mentioned problem, an information processing apparatus according to the present invention includes:

a database section which stores, in terms of documents accessible via a network and terms as words appearing in the documents, document clusters in each of which documents similar in appearance tendency of the terms are grouped;

a word extraction section which extracts a word from a specified document;

a document cluster identifying section which identifies, based on the extracted word, a document cluster associated with the specified document;

a keyword selection section which selects, as a keyword, a term appearing in the identified document cluster;

a content acquisition section which acquires, from the network, a content associated with the selected keyword; and

a display section which displays the acquired content together with the specified document.

According to the present invention, there can be provided an information processing apparatus which appropriately acquires a content associated with a document and displays the content together with the document.

### BRIEF DESCRIPTION OF THE DRAWINGS

FIG. 1 is a schematic configuration diagram of an information processing system according to a first embodiment of the present invention.

FIG. 2 is a functional block diagram of an information processing apparatus according to the first embodiment of the present invention.

FIG. 3A is a diagram illustrating examples of data stored in a database section 100.

FIG. 3B is another diagram illustrating examples of data stored in a database section 100.

FIG. 4 is a flowchart of the information processing apparatus according to the first embodiment of the present invention.

FIG. 5 is a schematic configuration diagram of an information processing system according to a second embodiment of the present invention.

### DETAILED DESCRIPTION OF THE INVENTION

Embodiments of the present invention will be described in detail below.

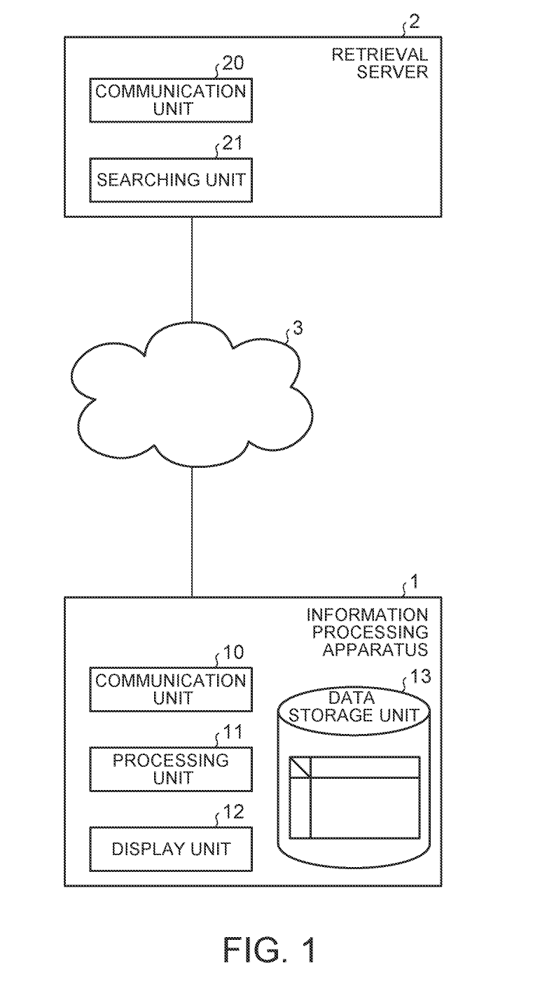

FIG. 1 is a schematic configuration diagram of an information processing system according to a first embodiment of the present invention. As illustrated in FIG. 1, an information processing apparatus 1 is configured to include a communication unit 10, a processing unit 11, a display unit 12, and a data storage unit 13. Further, a retrieval server 2 is configured to include a communication unit 20 and a searching unit 21. The information processing apparatus 1 and the retrieval server 2 are connected through a network 3. The information processing apparatus 1 accesses various pieces of information accessible via the network 3 according to user operations, which corresponds to, but is not limited to, a personal computer or a smartphone.

The communication unit 10 of the information processing apparatus 1 connects the information processing apparatus 1 to the network 3 to send and receive information. Specifically, the communication unit 10 can be configured of unillustrated wired LAN interface and wireless LAN interface, and control software or firmware therefor.

The processing unit 11 of the information processing apparatus 1 performs processing on various pieces of information. The processing for various pieces of information includes processing, which is not explicitly specified by a user, such as the control of each of units constituting the information processing apparatus 1, in addition to the execution of software specified by the user through an unillustrated input unit. The processing unit 11 can be configured of unillustrated CPU and memory.

The display unit 12 of the information processing apparatus 1 displays the information processing results by the processing unit 11 in such a manner that the user can view the results. The display unit 12 can be a display unit including a liquid crystal display panel and the like.

The data storage unit 13 of the information processing apparatus 1 stores various data in a nonvolatile manner. The various data may be received from the network 3 through the communication unit 10, or created based on user input through the unillustrated input unit. Further, the various data can be processing targets of the processing unit 11. The data storage unit 13 can be a nonvolatile storage device, such as a hard disk drive or an SSD (Solid State Drive).

The communication unit 20 of the retrieval server 2 connects the retrieval server 2 to the network 3 to send and receive information. Specifically, the communication unit 20 can be configured of unillustrated wired LAN interface and wireless LAN interface, and control software or firmware therefor.

The searching unit 21 of the retrieval server 2 performs a search in response to a search request accepted by the communication unit 20 via the network 3, and sends the search results to a requestor via the network 3. The search here is made to identify information having predetermined association with a keyword included in the search request. Such a search may be made based on data held in the retrieval server 2, or may be made by making a request to an information holding server different from the retrieval server 2.

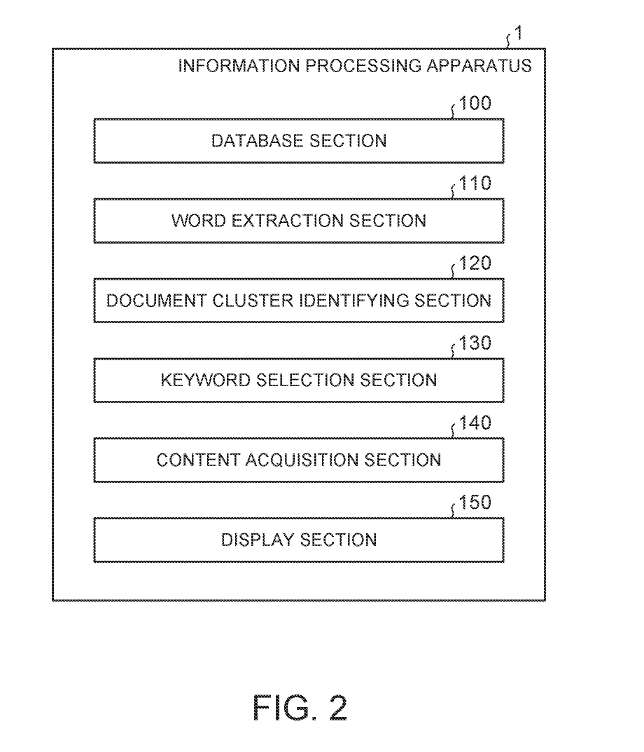

FIG. 2 is a functional block diagram of the information processing apparatus according to the first embodiment of the present invention. As illustrated in FIG. 2, the information processing apparatus 1 includes a database section 100, a word extraction section 110, a document cluster identifying section 120, a keyword selection section 130, a content acquisition section 140, and a display section 150.

The database section 100 stores, in terms of documents accessible via the network and terms as words appearing in the documents, term clusters in each of which terms similar in appearance tendency in the documents are grouped, and document clusters in each of which documents similar in appearance tendency of the term are grouped.

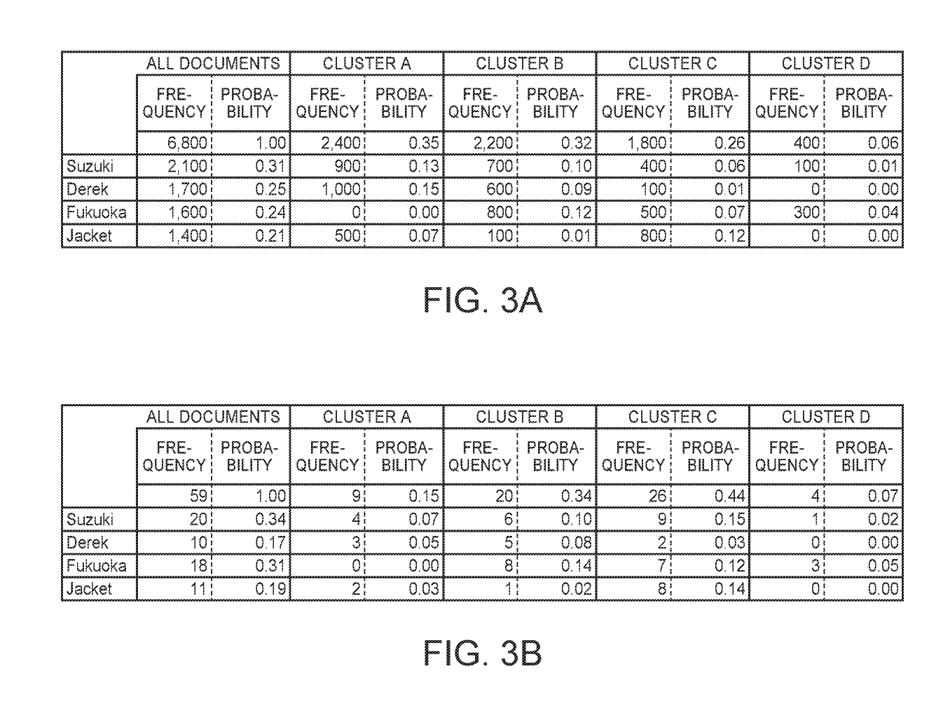

Examples of data stored in the database section 100 are illustrated in FIG. 3A and 3B. As illustrated in FIG. 3A, the database section 100 stores data as a table in which the documents are arranged in the X-axis direction and the terms are arranged in the Y-axis direction. A value at an intersection point between each document cluster and each term indicates the frequency of appearance of the term in the document cluster. In FIG. 3A, although both the number of appearances and the appearance probability are listed as the appearance frequency, either one of them may be listed. For example, only the number of appearances can be so stored that the probability will be calculated on a case-by-case basis.

In FIG. 3A, although the relations between four document clusters and four terms are listed for the purpose of illustration, terms are also clustered and stored in the same manner as the document clusters in practice. For example, when terms such as “Blouson” and “Suit” are similar in appearance tendency to the term “Jacket,” a term cluster in which these terms are grouped is stored. Further, the value of each individual document or term before being clustered may be stored together with the cluster value.

In FIG. 3A, the appearance probability is calculated by taking the total appearance frequency of all terms appearing in all documents as a denominator, and the total appearance frequency of a term in documents included in a document cluster as a numerator. From the appearance probability thus calculated, the characteristics unique to the document cluster to which the term belongs can be seen.

For example, it can be read from FIG. 3A that the number of times the term “Suzuki” appears in documents included in a document cluster B is 700, and the appearance probability of the term among all terms appearing in all documents is 0.10.

The database section 100 may also store a degree of interest identified for each term based on the history of operations to the information processing apparatus 1 carried out by a user of the information processing apparatus 1. The degree of interest is an estimate value of the degree of user's interest in the term, which can be calculated, for example, in such a manner that when the user carried out an operation to a certain document such as to view the document, a score corresponding to the operation is given to each term appearing in the document to count up the scores of the term.

An example of data stored in the database section 100 in this case is illustrated in FIG. 3B. A value at the intersection point between a document cluster and a term in FIG. 3B is a value obtained by summing up, for each term appearing in documents in the document cluster, scores given according to user operations to the documents, i.e., the value reflects the user's degree of interest.

The way of calculating the degree of interest is not limited to that mentioned above. The degree of interest can also be calculated by respectively providing and comparing appearance frequencies in documents accessible via a network and appearance frequencies in documents actually accessed by the user. In other words, a term higher in appearance frequency in the documents actually accessed by the user than in the documents accessible via the network can be determined to be higher in degree of user's interest.

Suppose that FIG. 3A represents appearance frequencies (total frequencies) in the documents accessible via the network, and FIG. 3B represents appearance frequencies (user frequencies) in the documents actually accessed by the user. In this case, since the total frequency of the term “Suzuki” in a document cluster C is 0.06 and the user frequency thereof is 0.15, the term can be determined to be high in degree of user's interest.

The database section 100 stores predetermined data in the data storage unit 13, which can be implemented by the processing unit 11 executing a predetermined database management program.

The word extraction section 110 extracts a word from a specified document. Here, the document means a content having corresponding text, such as a web page with a news article. The term “specified” here means that the document is selected from multiple targets. The document may be selected by the user, or by the apparatus according to a predetermined algorithm.

For example, the word can be extracted by performing morphological analysis on the text corresponding to the specified document. The word extraction section 110 can be implemented by the processing unit 11 executing a predetermined program.

The document cluster identifying section 120 identifies a document cluster associated with the specified document based on the extracted word. For example, a document cluster in which the appearance frequency of a term corresponding to the extracted word is high and the appearance frequencies of terms other than the extracted word are low can be identified as an associated document cluster. For example, a document cluster small in distance composed of a vector of the extracted word and a vector of the appearance frequency of each term in the document cluster can be identified as the associated document cluster.

Suppose that “Suzuki” and “Jacket” are extracted from the specified document to identify a document cluster associated with this document from data illustrated in FIG. 3A.

First, a case is considered where a document cluster high in the appearance frequency of a term corresponding to the extracted word and low in the appearance frequency of any term other than the extracted word is identified as an associated document cluster. The ranking of the appearance frequencies of “Suzuki” and “Jacket” corresponding to extracted words in each document cluster is as follows: Second and third in A, second and fourth in B, third and first in C, and second and third in D. The ranking of the appearance frequencies of terms “Derek” and “Fukuoka” other than the extracted words in each document cluster is as follows: First and fourth in A, third and first in B, fourth and second in C, and third and first in D. Providing that four points are given to the first place, three points are given to the second place, two points are given to the third place, and one point is given to the fourth place, scores of the extracted words and the terms other than the extracted words are counted up, respectively, and these scores are summed up. In this case, when the scores are summed up by multiplying, by minus one, the scores other than those of the extracted words, A is zero point, B is −2 points, C is two points, and D is −1 point. Thus, the document cluster C with the highest score is identified as the associated document cluster.

Next, a case is considered where a document cluster small in distance composed of a vector of each extracted word and a vector of the appearance frequency of each term in the document cluster is identified as the associated document cluster. When the words “Suzuki” and “Jacket” are extracted, vectors of these words are (0.5, 0, 0, 0.5) by normalizing the vectors to make the sum total become 1.0. Similarly, when vectors of the appearance frequencies of the respective terms in each document cluster are normalized, the vectors are (0.38, 0.42, 0.00, 0.21) in A, (0.32, 0.27, 0.36, 0.05) in B, (0.22, 0.06, 0.28, 0.44) in C, and (0.25, 0.00, 0.75, 0.00) in D, respectively. When the distances composed of these vectors are obtained as the total sums of absolute values of differences of values corresponding to respective terms, the total sums are 0.83 in A, 1.27 in B, 0.67 in C, and 1.50 in D. In this case, the document cluster C small in distance is identified as the associated document cluster.

In any of these cases, the calculation method of the scores or distances is just an example, and any other calculation method can be applied. For example, Euclidean distance may be used as the distance composed of vectors, or cosine similarity may be used.

The document cluster identifying section 120 can be implemented by the processing unit 11 executing the predetermined program. Although the case of identifying a document cluster from data in FIG. 3A is described here, it is needless to say that the document cluster can also be identified from data as in FIG. 3B.

The keyword selection section 130 selects, as a keyword, a term appearing in the identified document cluster. For example, a term high in appearance frequency in the identified document cluster can be selected as the keyword. A term high in appearance probability in the identified document cluster as a result of being compared with the appearance probability in all documents can also be selected as the keyword. Further, a term high in degree of interest in the identified document cluster when the database section 100 stores the degree of interest can be selected as the keyword.

It is considered a case where “Suzuki” and “Jacket” are extracted from a specified document, and terms appearing in the document cluster C identified as a document cluster associated with this document from data illustrated in FIG. 3A are selected as keywords.

The terms appearing in the document cluster C in FIG. 3A are “Suzuki,” “Derek,” “Fukuoka,” and “Jacket.” Since each of these terms has a relationship with the document cluster C, the terms can be selected as the keywords.

Among them, since “Jacket” and “Fukuoka” high in appearance frequency appear at high frequency in documents belonging to the document cluster C, these terms are suitable for being selected as keywords to acquire a content to be added to the documents.

Further, each appearance probability in the document cluster C and each appearance probability in all documents can be compared to select a keyword. The appearance probability in the document cluster C can be calculated by dividing the appearance frequency of each term in the document cluster C by the total appearance frequency in the document cluster C. When the values of the appearance frequencies of respective terms illustrated in FIG. 3A are used, the appearance probabilities in the document cluster C are 0.22, 0.06, 0.28, and 0.44, respectively. On the other hand, the appearance probabilities of the terms in all the documents to be compared with these values are 0.31, 0.25, 0.24, and 0.21, respectively.

When these are compared, the appearance probability of the term “Jacket” in the document cluster C is 0.44, whereas the appearance probability of the term in all the documents is 0.21. Thus, the appearance probability of the term “Jacket” in the document cluster C is high. Since such a keyword is a term appearing in an identified document cluster at high frequency, it is suitable for being selected as the keyword to acquire a content to be added to the documents. When the selection is made in this way, even if many common words (postpositional particles, etc.), which do not feature the document cluster but appear in the document cluster at high frequency, are included in the documents, a keyword can be selected appropriately with no effects of these common words.

Further, when the values of the appearance frequencies of respective terms illustrated in FIG. 3B are used to select terms as keywords, the appearance probabilities of the terms in the document cluster C are 0.35, 0.08, 0.27, and 0.31, respectively. On the other hand, the appearance probabilities of the terms in all the documents to be compared with these values are 0.34, 0.17, 0.31, and 0.19, respectively. Thus, the terms “Suzuki” and “Jacket” high in degree of interest can be selected. Since these terms are interested in by the user among the terms appearing in the documents belonging to the document cluster C, it is suitable for being selected as keywords to acquire a content to be added to the documents.

In selecting a term as a keyword from a document cluster, it can also be considered whether the term is extracted from a specified document. When a term which is not only appeared in or extracted from documents belonging to the document cluster but also is appeared in or extracted from the specified document is selected as a keyword, a more suitable document content and a higher degree of user's interest, compared with the way of acquiring the content to be added to the documents based on only the words appeared in or extracted from the specified document, can be reflected.

The keyword selection section 130 can be implemented by the processing unit 11 executing the predetermined program.

The content acquisition section 140 acquires, from the network, a content associated with a selected keyword. The content associated with the keyword is acquired, for example, by sending a search request together with the keyword as a search word to the retrieval server 2 connected through the network 3, and receiving, from the retrieval server 2, the retrieval results as information having predetermined association with the keyword. The content acquisition section can be implemented by the processing unit 11 executing the predetermined program, and the communication unit 10 performing communication through the network 3 as needed.

The display section 150 displays the acquired content together with the specified document. Since the specified document and the acquired content are displayed together, the user can access the associated content together with the document.

The content may be displayed in an area different from the area of the document on the screen, or displayed by adding the content into the document. When the document does not fit in one screen, the content may be added to and displayed in the area of the document that does not fit in one screen. In this case, the user can view the entire content by performing a scroll operation. Even so, however, the user can easily grasp that the content is displayed in association with the document.

The display section can be implemented by the processing unit 11 executing the predetermined program to control the display content of the display unit 12. Even if the information processing apparatus 1 does not have the display unit 12, the display section can also be implemented by controlling the display content of a display device (not illustrated) connected.

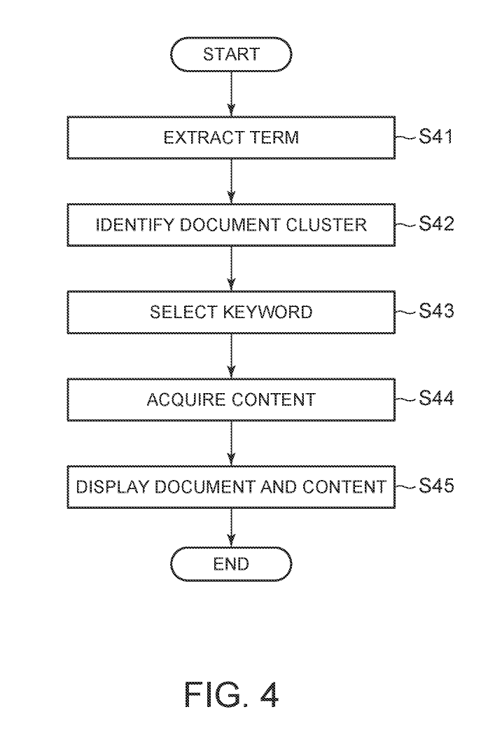

Referring next to FIG. 4, a flow of processing performed by the information processing apparatus 1 of the embodiment will be described. FIG. 4 is a flowchart of the information processing apparatus according to the first embodiment of the present invention.

First, in the information processing apparatus 1, the word extraction section 110 extracts a word from a specified document (step S41). Then, in the information processing apparatus 1, the document cluster identifying section 120 identifies, based on the word extracted in step S41, a document cluster associated with the specified document from among document clusters stored in the database section 100 (step S42).

Next, in the information processing apparatus 1, the keyword selection section 130 selects, as a keyword, a term appearing in the document cluster identified in step S42 (step S43). Then, in the information processing apparatus 1, the content acquisition section 140 acquires, from the network, a content associated with the keyword selected in step S43 (step S44).

Finally, in the information processing apparatus 1, the display section 150 displays the content acquired in step S44 together with the specified document (step S45).

Thus, the content having predetermined association with the content of the specified document can be acquired and displayed together with the document by executing the processing steps mentioned above.

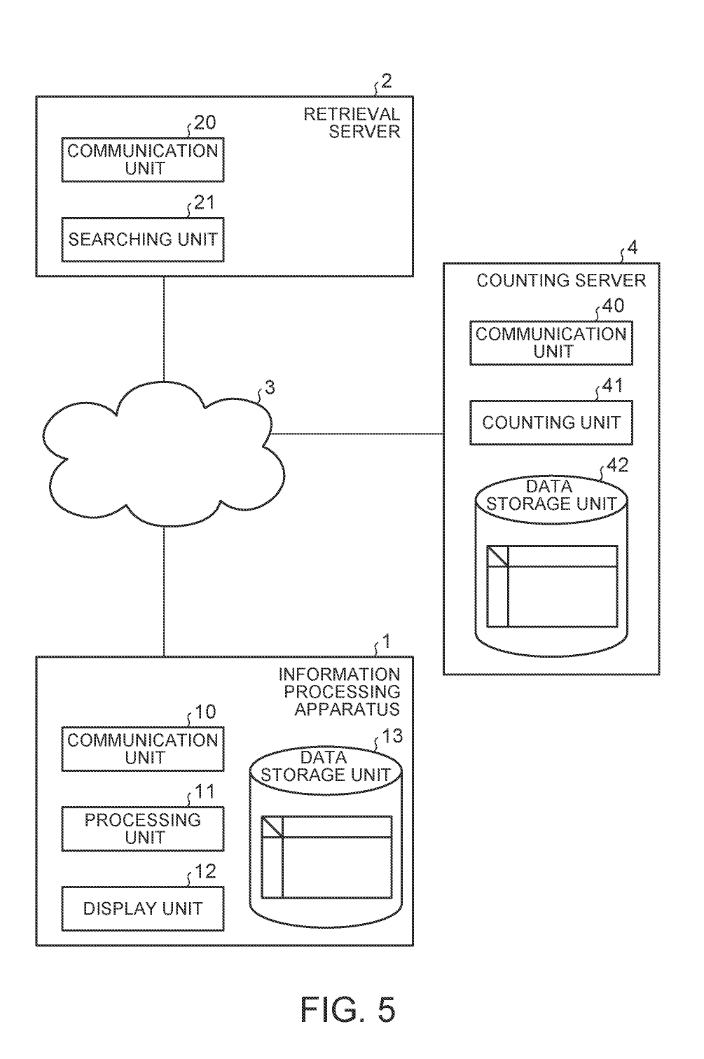

Next, a second embodiment of the present invention will be described. FIG. 5 is a schematic configuration diagram of an information processing system according to the second embodiment of the present invention. Since the second embodiment of the present invention differs from the first embodiment in that a counting server 4 is connected through the network 3 in addition to the information processing apparatus 1 and the retrieval server 2, the description of common parts will be omitted to mainly describe the different parts.

A counting server 4 counts terms as words appearing in each of documents accessible via the network to provide the terms to the information processing apparatus 1. The counting server 4 is configured to include a communication unit 40, a counting unit 41, and a data storage unit 42.

The communication unit 40 of the counting server 4 connects the counting server 4 to the network 3 to send and receive information. Specifically, the communication unit 40 can be configured of unillustrated wired LAN interface and wireless LAN interface, and control software or firmware therefor.

The counting unit 41 of the counting server 4 counts up data received by the communication unit 40 from the network 3. Specific counting processing will be described later. The counting unit 41 can be configured by an unillustrated processor executing a predetermined program.

The data storage unit 42 of the counting server 4 stores various data in a nonvolatile manner. The various data may be data obtained by the counting unit 41 counting up the data received by the communication unit 40 from the network 3. The data storage unit 42 can be a nonvolatile storage device such as a hard disk drive or an SSD (Solid State Drive).

The counting unit 41 stores, in terms of documents accessible via the network and terms appearing in the documents, term clusters in each of which terms similar in appearance tendency in the documents are grouped, and document clusters in each of which documents similar in term appearance tendency are grouped.

Suppose here that multiple apparatuses similar to the information processing apparatus 1 exist on the network 3 and these apparatuses are operated by different users. In this case, data stored in the database section 100 can, of course, be constructed individually by each information processing apparatus 1. However, the appearance tendency of terms in the documents accessible via the network is the same among all the information processing apparatuses 1. Therefore, if the data are constructed by the counting server 4 and at least some pieces of data are delivered to the information processing apparatus 1 through the network 3, the load on the information processing apparatus 1 can be reduced efficiently.

Further, the tendency of a user who operates each information processing apparatus 1 is first grasped by the information processing apparatus 1. Therefore, a database in which a degree of interest of the user in each term grasped by the information processing apparatus 1 is added to data on common appearance tendencies between documents and terms received from the counting server 4 can be built to acquire and display a content that matches the user's taste.

Alternatively, the number of times the user viewed each document grasped based on the history of user operations on the information processing apparatus 1 may be stored in categories according to the data on the common appearance tendencies between the documents and the terms received from the counting server 4. In this case, since the appearance frequencies in documents accessible via the network and the appearance frequencies in documents actually accessed by the user can be compared, a degree of interest can be determined.

While the preferred embodiments of the present invention have been described in detail, the present invention is not limited to the specific embodiments, and various modifications and changes are possible within the gist of the present invention as set forth in the appended claims.

We claim:

1. An information processing apparatus comprising:
a database section which stores, in terms of documents accessible through a network, terms appearing in the documents, and document clusters, wherein documents similar in term appearance tendency are grouped;
a word extraction section which extracts a word from a specified document;
a document cluster identifying section which identifies, based on the extracted word, a document cluster associated with the specified document;
a keyword selection section which selects, as a keyword, a term appearing in the identified document cluster;
a content acquisition section which acquires, from the network, a content associated with the selected keyword; and
a display section which displays the acquired content together with the specified document.

2. The information processing apparatus according to claim 1, wherein the keyword selection section selects, as the keyword, a term high in appearance frequency in the identified document cluster.

3. The information processing apparatus according to claim 2, wherein the keyword selection section selects, as the keyword, a term higher in appearance probability in the identified document cluster than the appearance probability of the term in the documents accessible via the network.

4. The information processing apparatus according to claim 1, wherein the database section stores a degree of interest identified for each of the terms based on a history of operations to the information processing apparatus by a user of the information processing apparatus.

5. The information processing apparatus according to claim 4, wherein the keyword selection section selects, as the keyword, a term high in degree of interest in the identified document cluster.

6. The information processing apparatus according to claim 1, wherein the document cluster identifying section identifies a document cluster in which the appearance frequency of the term corresponding to the extracted word is high and the appearance frequency of any term other than the extracted word is low.

7. The information processing apparatus according to claim 1, wherein the document cluster identifying section identifies a document cluster small in distance composed of a vector of the extracted word and a vector of the appearance frequency of each term in the document cluster.

8. The information processing apparatus according to claim 1, wherein the content acquisition section acquires, as the content, a search result using the selected keyword as a search word, which is acquired from a retrieval server connected to the network.

9. An information processing system comprising an information processing apparatus and a server connected through a network, wherein:
the server comprises:
a first database section which stores, in terms of documents accessible via the network and terms as words appearing in the documents, document clusters, in each of which documents similar in appearance tendency of the terms are grouped, and
the information processing apparatus comprises:
a second database section which receives and stores, from the server, at least some of the document clusters stored in the first database section;
a word extraction section which extracts a word from a specified document;
a document cluster identifying section which identifies, based on the extracted word, a document cluster associated with the specified document;
a keyword selection section which selects, as a keyword, a term appearing in the identified document cluster;
a content acquisition section which acquires, from the network, a content associated with the selected keyword; and
a display section which displays the acquired content together with the specified document.

10. An information processing method comprising:
a database storing step of storing, in terms of documents accessible via a network and terms as words appearing in the documents, document clusters, in each of which documents similar in appearance tendency of the terms are grouped;
a word extraction step of extracting a word from a specified document;
a document cluster identifying step of identifying, based on the extracted word, a document cluster associated with the specified document;
a keyword selection step of selecting, as a keyword, a term appearing in the identified document cluster;
a content acquisition step of acquiring, from the network, a content associated with the selected keyword; and
a display step of displaying the acquired content together with the specified document.
